(19) United States
(12) Patent Application Publication
(10) Pub. No.: US 2002/0186621 A1
(43) Pub. Date: Dec. 12, 2002

(54) Nested menu digital watch

(76) Inventor: Jimmy Lai, Oakland, CA (US)

Correspondence Address: GARY CARY WARE & FREIDENRICH LLP, 1755 EMBARCADERO ROAD, PALO ALTO, CA, 94303-3340, US

(21) Appl. No.: 09/849,957

(22) Filed: May 4, 2001

Related U.S. Application Data
(60) Provisional application No. 60/201,968, filed on May 5, 2000.

(51) Int. Cl. G04C 19/00

(52) U.S. Cl. 368/82

(57) ABSTRACT

A multimode digital watch having a dot matrix digital display embedded in a watch face and a controller, wherein the controller presents a series of primary menu images on the dot matrix display in response to a first set of signals from the user activated input device, each primary menu image identifying one of a plurality of modes in a primary menu, and presents a series of secondary menu images on the dot matrix display corresponding to a primary mode present on the dot matrix display when a second set of signals is provided by the user activated input device; wherein the series of primary menu images is presented bi-directionally, and in one embodiment the primary menu images are formed of alphanumeric characters and icons which can be animated.

### RELATED APPLICATIONS

The present application claims priority under 35 U.S.C. §119(e) from provisional application No. 60/201,968 filed May 5, 2000.

### FIELD OF THE INVENTION

The invention relates generally to timepieces, and more particularly, to a digital watch that provides multiple functional displays in a digital format which are navigated by way of nested menus.

### DESCRIPTION OF RELATED ART

Wristwatches having a digital display for the time and date are well known. Digital displays such as light emitting diode (LED) and digital segment liquid crystal displays are well known.

Multimode or multifunction wristwatches are also well known. Generally, these multimode watches include an integrated circuit programmed in a predetermined sequence for cycling the watch through the various modes in which different information is displayed for each mode. As described in U.S. Pat. No. 4,912,688, these watches have various modes, such as the time of day, chronograph, dual time zone, and elapsed time. Typically, a switch on the watch is actuated to cycle the watch display to the next mode.

In the conventional multimode watch, once a mode has been cycled to the next mode, the watch buttons are immediately enabled to begin implementing the functions within the mode. For example, when one cycles to the time setting mode, typically the pushing of another one of the buttons on the watch will cause a change in the time. As a result, changes or functions can be initiated inadvertently. Another disadvantage is that it is sometimes difficult to differentiate one mode from another because subtle changes in secondary areas, not the primary digital time segments, are sometimes used to signal the user as to a change in mode or function. With such an arrangement, the user sometimes has difficulty in identifying the current mode because of the limited clues provided by the display. Another disadvantage of conventional multimode watches is that the modes are cycled through in one direction, thereby requiring the user to cycle through the entire set of modes to get to a just passed.

It would therefore be desirable to have a multimode watch in which the operational modes are more easily navigated; where the modes are more clearly discernible, and where the modes can be accessed in more than a single direction.

### SUMMARY OF THE INVENTION

The present invention is a multimode digital watch which has nested menus. In the preferred embodiment the primary menu is navigable both forward and backwards. The menu presents one mode at a time, and the presented mode is entered when the user affirmatively selects it. In one embodiment the modes are identified using a combination of words and animations. In accordance with the present invention, animations are used in the menus to identify a mode before the user actually selects a mode.

These and other features of the present invention provide a multimode digital watch which is easier to navigate and easier to use, and in which the modes are more easily identified. These and other features and advantages of the present invention will be more readily understood upon consideration of the following drawings and detailed description of the present invention.

### BRIEF DESCRIPTION OF THE DRAWINGS

The invention will be better understood by reference to the attached figures in which:

FIG. 1 is a perspective view of the watch body and buttons of an embodiment of the present invention;

FIG. 2A is a view of one side of the embodiment shown in FIG. 1 showing the navigational buttons;

FIG. 2B is a view of another side of the embodiment shown in FIG. 1 showing the navigational buttons;

FIG. 3 is a top plan view of the watch body, buttons, and dot matrix liquid crystal digital display used in an embodiment of the present invention;

FIG. 4 is a block diagram of the circuitry of the watch of the present invention;

FIGS. 5A and 5B provide an example of the nested menus of the present invention.

### DETAILED DESCRIPTION OF THE INVENTION

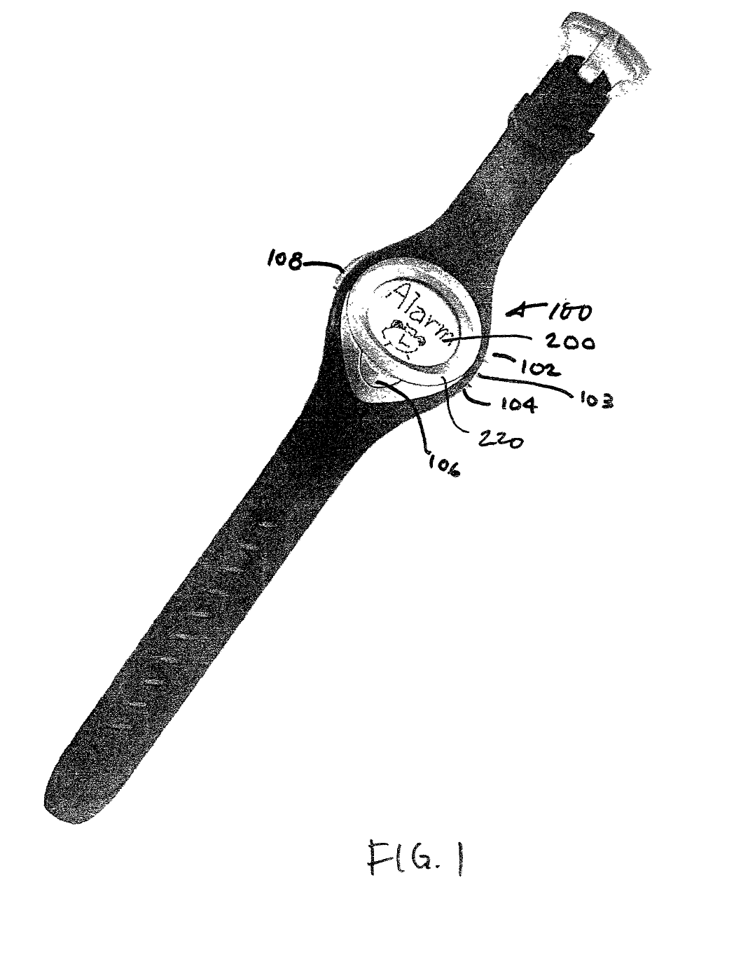

The present invention is a watch 100 that has a watch face 200 on its top side having a dot matrix liquid crystal display (LCD) for the digital display 210. The watch face 200 has a frame 220 around it and is covered with a watch crystal 225, as shown in FIG. 1. In a preferred embodiment, the frame 220 is round, preferably oval. The frame 220 may also be square or rectangular or any other shape.

Watch 100 is provided with several buttons for controlling its operation. Buttons 102 and 104 are UP and DOWN (toggle) controls, respectively. Button 106 is an ENTER button. Button 108 is an ESCAPE or EXIT button. In the illustrated embodiment, the protocol used is that when the UP button 102 or DOWN button 104 is used to change the digit or selection, the ENTER button 106 confirms the selection or digit. Also, pressing the ESCAPE or EXIT button 108 will cause the display to revert to the Time Display mode.

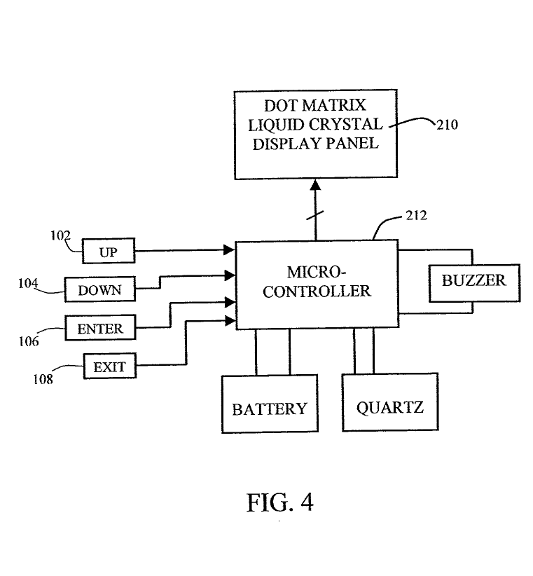

The dot matrix LCD 210, is shown in FIG. 3 embedded in the watch face 200 within the frame 220, and is employed to provide the various visual displays for the different functional modes. It is to be understood that the number of pixels shown in LCD 210 of FIG. 3 is for illustrative purposes only, and that in practice the number of pixels used will be selected according to the resolution desired for the display.

In the embodiment shown in FIG. 3, a commercially available LCD is used for the dot matrix LCD 210 as set forth in the following TABLE 1. The digital display 210 is controlled by a digital controller 212 that determines the information to be displayed on the dot matrix LCD 210. In a preferred embodiment, the watch processor controller 212 is a commercially available device as set forth in the following TABLE 2.

TABLE 1
LCD

| model number | 93-40811-1500b |
|---|---|
| manufacturer | Elec & Eltek Display Technology Ltd. |
| city | Guangzhou |
| state/country | China |
| number of dots | 1024 |
| LCD Type | STN |
| no. of segments | 64 |
| no. of common | 16 |
| Duty | 1/16 |
| Bias | 1/5 |

TABLE 2
Watch controller (CPU)

| | |
|---|---|
| Model number | SPL-191A |
| Manufacturer | Sunplus Technology Ltd. |
| City | Science-Based Industrial Park |
| State/country | Taiwan |

Circuitry Operation

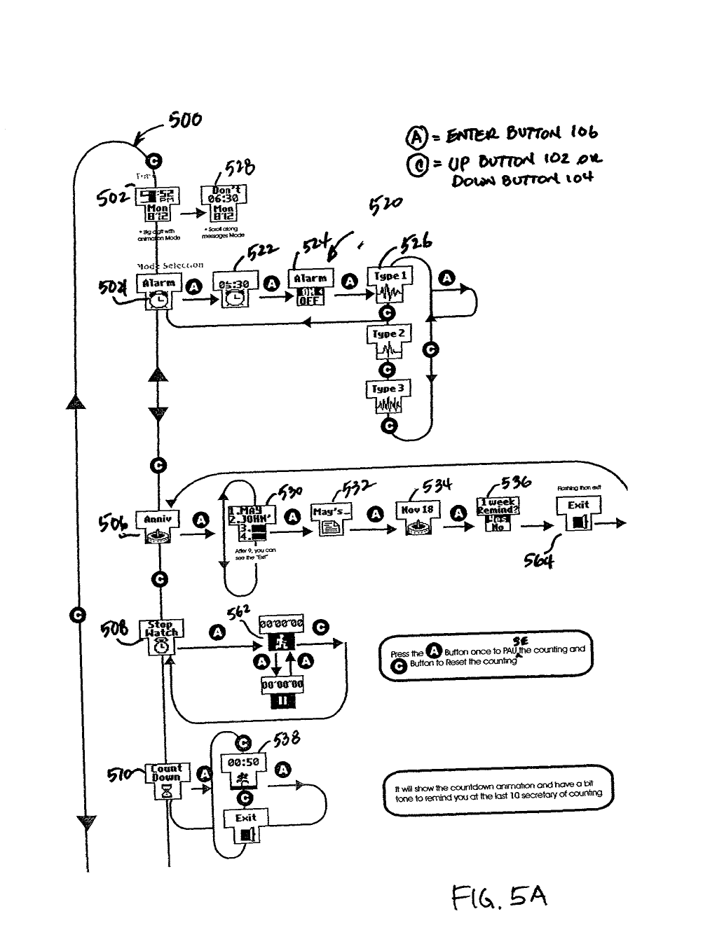

In a preferred embodiment, the watch 100 uses a controller 212 which is an integrated circuit, part number SPL-191A, available from Sunplus Technology Co., Ltd., of Science-Based Industrial Park, Taiwan, for controlling the dot matrix LCD 210 to display the different animations and alphanumeric information. The controller circuit 212 includes an LCD driver and a memory section that stores bit patterns to be used in the animations and alphanumeric display. FIG. 4 is a block diagram of the circuitry of the watch 100. As described briefly earlier, the user uses the UP key 102 and the DOWN key 104 to move back and forth between items. The ENTER key 106 is used to select a mode or function, to operate the program of the CMOS circuit 212 to cycle to other modes and to set the time. EXIT key 108 is employed to exit out of a function or mode, and/or to return to the default display mode, such as the TIME mode.

As shown in FIG. 4, the inputs sent from the UP key 102, DOWN key 104, the ENTER key 106, or the EXIT key 108 are received by the controller 212, which is powered by a battery . The controller 212 in turn controls the dot matrix LCD 210 and provides the bit patterns to the dot matrix LCD 210 to be displayed. Included within the circuitry is a quartz crystal oscillator upon which the timing and other signals are based.

Operational Modes

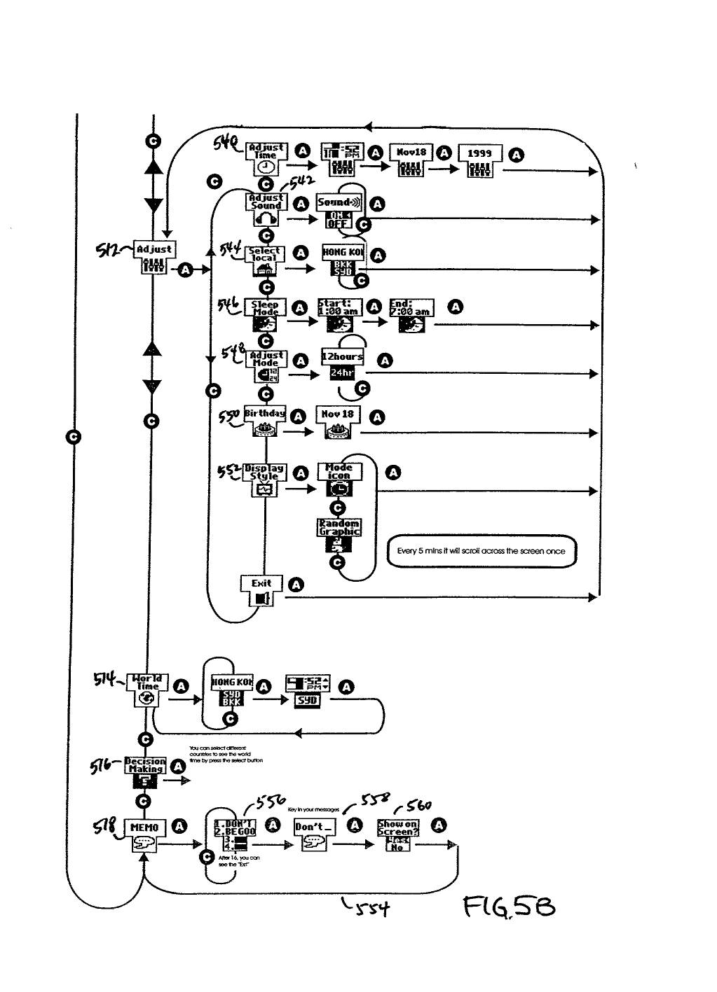

The controller 212 of an embodiment of the present invention is programmed to provide the progression of operations shown in FIGS. 5A and 5B. This embodiment has NINE (9) modes of operation. These nine (9) modes are set forth in the following Table A:

TABLE A

| MODE | REFERENCE NUMBER: |
|---|---|
| Time | 502 |
| Mode Selection - Alarm | 504 |
| Mode Selection - Anniversary | 506 |
| Mode Selection - Stop Watch | 508 |
| Mode Selection - Count Down | 510 |
| Mode Selection - Adjust | 512 |
| Mode Selection - World Time | 514 |
| Mode Selection - Decision Making | 516 |
| Mode Selection - Memo | 518 |

Navigation through these nine (9) modes is accomplished using a primary loop 500 and secondary loops. The primary loop 500 is bi-directional. For example, when in the primary loop 500 the user presses DOWN button 104, the modes are sequenced through in a clockwise direction around loop primary 500. Pressing UP button 102 causes the modes to be cycled in a counterclockwise direction around primary loop 500.

When a mode is reached that the user wishes to enter, the user presses ENTER button 106. When the user desires to leave a selected mode, the user presses the EXIT button 108 which causes the watch to revert to the Time mode 502.

For example, when the primary loop 500 has been cycled to the “Alarm” mode 504, pressing the ENTER button 106 causes the watch to enter the Alarm secondary loop 520. Subsequent pressing of the ENTER button 106 causes the watch to progress through secondary loop 520. Thus, as can be seen in FIG. 5A and set forth in Table B, in secondary loop 520, there are three modes that can be cycled through:

TABLE B

| SECONDARY LOOP MODE | REFERENCE NUMBER |
|---|---|
| Alarm Set | 522 |
| Alarm ON/OFF | 524 |
| Alarm Type | 526 |

Once a secondary loop mode has been cycled to, pressing UP button 102 or DOWN button 104 will provide access to the modes available for that secondary loop mode. For example, when the Alarm Type secondary loop mode 526 is reached, pressing UP button 102 or DOWN button 104 permits the user to cycle through the three types of alarm sounds that are available in the illustrated embodiment. Pressing enter button 106 confirms the selection made. Pressing the EXIT button 108 causes the watch to revert to Time mode 502.

In Time mode 502 the user is able to cycle between a mode (502) which displays the time in large digits, and the day of the week and numerical month and day below; or a mode 528 in which a message and the alarm time are shown in the upper part of the display, and the day of the week and numerical month and day in the lower part. In both modes, the day of the week is indicated in letters.

For the anniversary mode 506, the secondary loop mode permits the user to cycle through a list 530 of nine (9) entries using UP button 102 or DOWN button 104. Also within the list is an EXIT selection. When one of the list is selected by pressing ENTER button 106, the ENTER button 106 thereafter cycles through the information that can be set for that one of the list, as set forth in the following Table C.

TABLE C

| SETTABLE INFORMATION | REFERENCE NUMBER |
|---|---|
| Name | 532 |
| Date | 534 |
| Early Reminder | 536 |

An EXIT selection is also provided to permit the user to exit out of the secondary loop.

In any one of the particular settable information selections, the UP button 102 or DOWN button 104 is used to scroll to the digits, letters or settings to be selected. For example, in selectable item Early Reminder 536, pressing UP button 102 or DOWN button 104 permits the user to select either YES or NO. Thereafter pressing ENTER button 106 confirms the selection.

In the ANNIV mode, when entering the name of the person whose anniversary is being recorded at icon 532, the watch is placed in the memo mode. In this mode, the first letter of the name is first presented in a condition to be set. The UP button 102 and DOWN button 104 are used to scroll through a list of possible characters. Also included in the list are a BACK selection and an EXIT selection. The BACK selection permits the user to go back to the character that was previously set. The EXIT selection permits the user to exit the setting of the characters for the name. When in this list of possible characters, the ENTER button 106 is used to confirm the selection. When a letter of the name has been selected, the watch presents the next letter of the name to be set. This continues until the user selects the EXIT selection to exit out of the name setting mode.

Referring now to the Stop Watch mode 508, pressing ENTER button 106 causes the Stop Watch mode to toggle between run and pause. Pressing the UP button 102 or DOWN button 104 causes the count to be reset.

For the Count Down mode 510, pressing ENTER button 106 causes the watch to display the count down time 538. Pressing UP button 102 or DOWN button 104 permits the user to select the count down time. Thereafter, pressing ENTER button 106 starts the count down timer.

Adjust mode 512 permits the user to adjust the functions set forth in TABLE D:

TABLE D

| FUNCTION | REFERENCE NUMBER |
|---|---|
| Adjust Time | 540 |
| Adjust Sound | 542 |
| Select Local Time | 544 |
| Sleep Mode | 546 |
| Adjust Mode | 548 |
| Birthday | 550 |
| Display Style | 552 |

World Time mode 514 permits the user to select different countries to display the corresponding time in the selected country.

Decision Making mode 516 provides an output which is randomly selected from a predetermined number of different and sometimes fanciful decision making outcomes such as:

EXAMPLE DECISIONAL OUTCOMES

| | | |
|---|---|---|
| Yes | Absolutely not | I don't Know |
| Yeah baby! | Don't bother | No clue |
| Count on it! | Fuhgedaboutit! | Can't say |
| Of course | When pigs fly! | Check it later |
| No | Doubtful | |
| Fat Chance | Maybe | |

The Memo mode 518, in the illustrated embodiment, provides the user up to sixteen (16) programmable memo items. The secondary loop 554 for the Memo mode 518 cycles the user through the functions shown in TABLE E.

TABLE E

| FUNCTION | REFERENCE NUMBER |
|---|---|
| Select Memo | 556 |
| Key in Memo | 558 |
| Show on Screen? | 560 |

As can be appreciated from the above illustrative embodiment of the nested menus of the present invention, such a configuration permits a large number of modes, and functions with each mode, and features within each function, to be available to the user. The nested menus of the present invention permit the user to be presented with a list of modes, one mode at a time, at the primary menu level. This permits the user to scroll through the list without causing the mode to be selected at the same time. This avoids inadvertent activating of a mode and inadvertent changing of mode settings, such as when the watch buttons are accidentally hit by an object.

This displaying of the identity of one mode at a time also permits more information to be provided in the display which makes the mode easier to identify to the user.

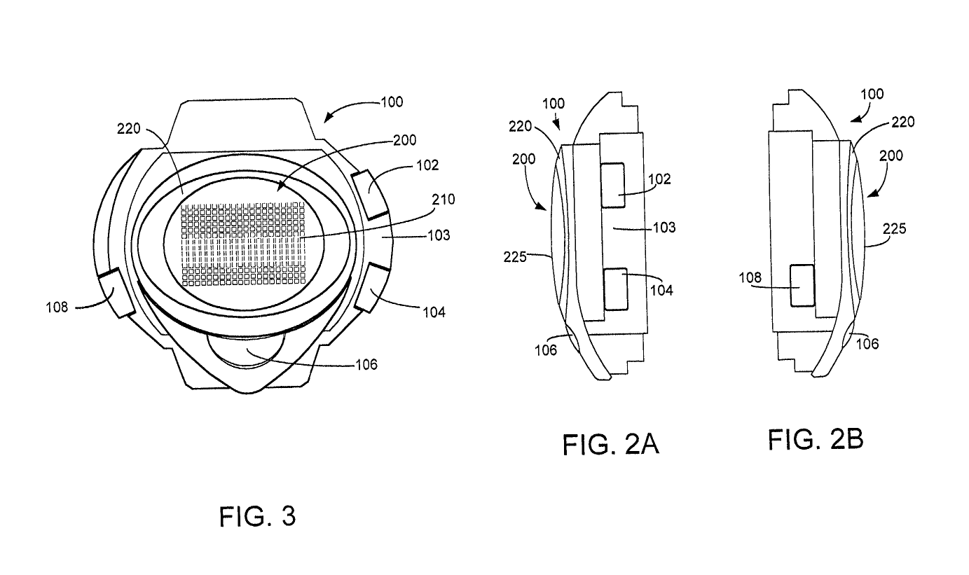

Further, the bi-directional scrolling feature, permits the user to more easily scroll to a mode. Instead of having to scroll through the entire list of modes, as is the case in the prior art, the present invention permits the user to scroll backwards and forward through the list of modes. The buttons 102 and 104 are specially designed and placed to aid in implementing the bi-directional scrolling feature. As can be seen from FIGS. 1, 2A, 2B and 3, buttons 102 and 104 are located along the right side edge of the watch body, relative to a fixed spacer section 103, and are generally elongated in shape. Button 102 is positioned to the counterclockwise side of fixed spacer section 103, while button 104 is positioned to the clockwise side. The relative positioning and the elongated shape of buttons 102 and 104 suggest to the user the counterclockwise versus clockwise scrolling that each button initiates. It follows that, in the illustrated embodiment, pressing button 102 results in a counterclockwise scrolling through a menu, while pressing button 104 results in a clockwise scrolling.

As discussed above, one of the features of the present invention is the use of icons/word combinations to further enhance and convey to the user the identity of the function being depicted. In FIGS. 5A and 5B, the use of the combination icons and words can be seen in accordance with the present invention. For example, the Count Down mode 510 in the primary menu 500 is depicted by the combination of the words Count Down, and an hour glass icon. Some of the other depictions in primary menu 500, and other submenus are listed in the following TABLE F.

TABLE F

| MODE/FUNCTION | WORD/LETTERS | ICON |
|---|---|---|
| Alarm 504 | Alarm | Clock Face |
| Sound Variation Type 526 | Type 1 | Graphical Trace |
| Anniversary Reminder 506 | Anniv | Cake w/candle |
| Stop Watch 508 | Stop Watch | Clock Face |
| Adjustment 512 | Adjust | Slide bars |
| Memorandum 518 | Memo | Dialog bubble |
| Running Time 562 | 00’00”00 | Running stick |
| | | character |
| Exit 564 | Exit | Open door |
| Sleep 546 | Sleep Mode | Moon with night cap |
| Display Style 552 | Display Style | TV screen |
| Adjust Time 540 | Adjust Time | Clock face |
| World Time 514 | World Time | Globe |

The icon/word identifications can be provided in part because the primary loop of the preferred embodiment of the present invention scrolls through a list of modes, rather than into each mode. Thus, unlike the prior art which might permit a user to move to an “time set mode” in which one of the digits is already flashing and ready to be changed, the present invention will present the user with a display that shows the word “Adjust” and an icon made up of slider bars 512. If the user selects the “Adjust” mode, the user is presented with a sub-menu in which provides a list, also in icon/word form, of several different functions or sub-modes which can be selected for adjustment. See Table D above. Therefore, instead of scrolling to the adjustment of a single function in the primary loop, the user, in accordance with the present invention, scrolls to an identified mode, and upon selecting the identified mode, is presented with a sub-menu which in turn lists many possible actions.

In the present invention, the icons being used are sometimes animated in order to enhance the intuitive understanding of the mode or function being represented by the icon/animation. Thus, for example, the following icons listed in Table G are animated:

TABLE G

| MODE/FUNCTION | ICON BEING ANIMATED/ACTION |
|---|---|
| Alarm 504 | Alarm clock/Ringing |
| World Time 514 | Globe/Turning |
| Count Down 510 | Hour Glass/Turns and flips |
| Anniversary 506 | Cake/Dots circle cake |

In one embodiment of the present invention, the animations are generated by displaying preprogrammed bit map patterns for each frame of the animation. In other words, there is a bit map pattern created beforehand for each possible alphanumeric character and image variation. These patterns are stored within the controller read only memory, and read out as required. In this manner, a fast and smooth animation can be generated. It is to be understood, however, that other methods of generating the animations can be employed within the spirit of the present invention.

It is to be appreciated that the description and details provided herein are meant to illustrate and not to limit the present invention, it being contemplated that alterations and modification of the system described as well as the various interrelationship of the components and methods illustrated will become apparent to those skilled in the art after having considered the foregoing description and accompanying drawings.

What is claimed is:

1. A multimode watch having a watch face, comprising:
a dot matrix display positioned on the watch face;
a user activated input device;
a controller which presents images on the dot matrix display in response to signals from the user activated input device;
wherein the controller presents a series of primary menu images on the dot matrix display in response to a first set of signals from the user activated input device, each primary menu image identifying one of a plurality of modes in a primary menu, and presents a series of secondary menu images on the dot matrix display corresponding to a primary mode present on the dot matrix display when a second set of signals is provided by the user activated input device.

2. The multimode watch of claim 1, wherein the controller provides the series of primary menu images bi-directionally.

3. The multimode watch of claim 1, wherein the primary menu images are formed of alphanumeric characters and icons.

4. The multimode watch of claim 3, wherein the icons are animated.

5. The multimode watch of claim 1 wherein one of the series of secondary menu images identifies an exit function.

6. The multimode watch of claim 1, wherein the user activated input device includes a plurality of buttons.

7. The multimode watch of claim 6, wherein a pair of the plurality of buttons provide up and down commands.

8. The multimode watch of claim 7, wherein a further button of the plurality of buttons provides an enter command.
